(19) United States
(12) Patent Application Publication
(10) Pub. No.: US 2004/0208285 A1
(43) Pub. Date: Oct. 21, 2004

(54) Miniature X-ray source and catheter system

(76) Inventors: Joerg Freudenberger, Baiersdorf (DE); Peter Schardt, Hoechstadt A.D. Aisch (DE)

Correspondence Address: SCHIFF HARDIN, LLP, PATENT DEPARTMENT, 6600 SEARS TOWER, CHICAGO, IL, 60606-6473, US

(21) Appl. No.: 10/756,609

(22) Filed: Jan. 13, 2004

(30) Foreign Application Priority Data
Jan. 13, 2003 (DE) 10300926.4
Sep. 9, 2003 (DE) 10341538.6

(51) Int. Cl. H05H 1/00; G21G 4/00; H01J 35/00

(52) U.S. Cl. 378/119

(57) ABSTRACT

An X-ray source to be introduced into the body vessels of a living being by means of a catheter is designed as a laser plasma X-ray source and is arranged in a housing, which has a diameter of a maximum of about 2 mm transversely to the direction from which the X-ray source is intended to be introduced into the body vessel. A catheter with such an X-ray source and a system for an intracorporeal X-ray source irradiation with such a catheter also are provided.

### BACKGROUND OF THE INVENTION

1. Field of the Invention

The present invention relates to an X-ray source of the type to be introduced into body vessels, especially the veins and arteries, of a living being, by means of a catheter. Furthermore, the invention concerns a catheter with a corresponding X-ray source, as well as a system for intracorporeal X-ray irradiation with such a catheter.

2. Description of the Prior Art

X-ray sources of the aforementioned type have been used, e.g., for the X-ray radiation treatment of diseases inside patients' bodies. They have the advantage that they can be placed in close proximity to the tissue to be treated and, therefore, essentially only the tissue to be treated is affected by the X-rays. Healthy tissue that could be damaged by the radiation is not affected or is affected only slightly. A typical field of application for such X-ray sources is the treatment of contracted arteries or veins (angiostenosis), especially in heart vessels. In most cases, such angiostenosis is treated by the so-called “balloon dilatation”, e.g., by percutaneous transluminal coronary angioplasty (PTCA). In this process, the plaque causing the narrowing of the vessel's inner profile is partially crushed. This method is quite effective, however, its disadvantage is that the PTCA treatment triggers an injury healing process, which results in the so-called “restenosis”, i.e., a repeated narrowing of the vessel's inner profile. Currently, in 30 to 50% of the cases where patients with stenosis undergo a PTCA treatment, restenosis develops within about half a year. Although this occurrence of restenosis can be reduced to a rate of about 28% using the so-called “stents”, a better goal would be to achieve a stenosis-free condition for a longer interval.

The current catheters that are used to achieve an effective reduction of restenosis deliver a radioactive preparation to the location of stenosis in order to apply ionizing radiation to the vessels to be treated. This type of treatment significantly lowers the probability of the occurrence of restenosis. The radioactive preparations are usually high-energy radiation sources emanating gamma or beta rays. The use of such preparations has various disadvantages. First, these radioactive preparations must be manufactured in relatively costly installations such as linear accelerators. Radiation sources manufactured in this manner cannot be switched off, i.e., they must be introduced in the body vessels in specials catheters and must be shielded as best as possible on the way to and from the place to be treated. The preparations usually can be used only once. After the treatment, the radioactive preparations must be either discarded in an appropriate manner or they must be regenerated, or, alternatively, they can be stored—while appropriately shielded—until the radiation decays to the point where it is under a pre-defined level. In addition, costly measures must be taken during the use of such radioactive preparations to comply with the relevant radiation protection regulations. So, for example, it is mandatory that a specially trained nuclear medicine specialist be present during any treatment involving radioactive preparations.

In order to avoid these disadvantages, miniaturized X-ray sources have been developed, which—in the same manner as the radioactive preparations—are introduced into the site to be treated by means of a catheter. However, in contrast to a radioactive preparation, an X-ray source can be switched on and off directly on the site. This allows one to apply the dose relatively exactly in space and time. Moreover, any radiologist can use such an X-ray source. Thus, the presence of a specially trained nuclear medicine specialist is no longer required.

As long as proper sterilization is ensured, such an X-ray source is suitable for multiple uses. Furthermore, discarding this type of X-ray source is relatively easy.

German OS 198 25 999 and German OS 198 28 616 describe an exemplary design of suitable X-ray sources. In this case, the X-ray sources are miniaturized X-ray tubes of the conventional type. The X-ray tube is supplied with a high voltage current through a cable installed and connected to the catheter. The current accelerates electrons produced in the conventional manner, which generate X-ray radiation upon impacting a target located in the miniaturized X-ray tube. However, this design is very disadvantageous because it must be connected to a high-voltage current (in the magnitude of 10 to 30 kV). In the case of a system failure, this could cause disaster. Also, the manufacture of the corresponding catheters requires the use of very costly high-voltage cables with a thin cross-section.

Furthermore, Japanese Application 09-134796 discloses an X-ray source with a tube that—in the case of, for example, radiation therapy in the area of the uterus or in the larynx—can be introduced into the body orifices of a patient. In this design, an electron beam is generated and accelerated in the conventional manner outside the tube. The electron beam is then led through a relatively short, flexible, tube-like component into the tube and there it is aimed at an X-ray anode. The German PS 100 27 149 discloses a particle-induced X-ray source, in which the actual X-ray source is movable relative to the particle source. The patent proposes to use—as the particle source—an electron beam and a photon beam, in particular a laser beam, and—as the means to transport the particles to the X-ray source—a mirror system, optical fibers, or hollow shaft conductors. The X-ray source is located in an operating head the size of a chemical test tube or a laser pointer. The X-ray source described therein can be used to examine hollow space such as technical tubes, but also inside the human body via body orifices, i.e. endoscopy examinations. However, neither of the two aforementioned X-ray sources is suitable for introduction into the body vessels of a living being by means of a catheter.

### SUMMARY OF THE INVENTION

An object of the present invention is to provide a simple and cost-efficient X-ray source of the aforementioned type that is especially suitable for use in the area of coronary arteries, and one that does not require the introduction of high-voltage-conducting components into the body of the living being.

The above object is achieved in accordance with the principles of the present invention in a miniature X-ray source adapted for introduction into a vessel in the body of a living subject by means of a catheter, wherein the X-ray source is a laser plasma X-ray source disposed in a housing, and wherein the housing has a diameter, transversely to the direction of the intended introduction of the X-ray source into the vessel, of no more than about 2 mm.

The invention employs a laser plasma X-ray source, and this is miniaturized in a convenient manner. This laser plasma X-ray source irradiates a solid body target with a high-intensity laser radiation. The interaction of the laser with the target causes plasma to generate relatively quickly on the surface of the target. Due to the collective absorption mechanisms, part of the laser energy is converted into hot electrons, which are accelerated to energies of up to several keV and then hit the relatively “cold” solid body behind the plasma. The K-shell ionization and bremsstrahlung radiation cause the X-ray beams to generate subsequently in the solid body target. These mechanisms are described, for example, in the articles “Yield Optimization and Time Structure of Femtosecond Laser Plasma K a Sources” by Ch. Reich et al. in Phys. Rev. Let. 84 (21), 2000, and in the article “Laser-based micro-focused X-ray source for mammography: Feasibility study” by A. Krol et al. in Med. Phys. 24 (5), 1997. According to the invention, the laser plasma X-ray source is arranged in a housing—at least in some areas penetrable by X-ray radiation—that has a diameter of a maximum 2 mm vertical to the direction from which the X-ray source is introduced into the body vessel. As used herein, the term “diameter” means the distance between two mutually most distant points on the contour of a cross-section through the housing transversely to the direction of introduction. Preferably, the housing has a round or oval cross-section.

Since the X-ray source can, by means of the catheter, be brought directly to the place of application, the required X-ray output is usually quite small. So for example, the conventional X-ray tubes manufactured according to the aforementioned state of the art require, for the treatment of stenosis, only about 1 watt of electrical output. Lasers with a light output sufficient to generate an adequate X-ray output in the laser plasma X-ray source according to the needs of the invention are already available.

The main advantage of the laser plasma X-ray source that can be introduced into body vessels as designed by the invention consists in the fact that, unlike other conventional X-ray sources used for this purpose, no dangerously high voltages are required to be inside the body. Instead of expensive, thin high-voltage cables, the invention allows one to use optical conduits that are very thin, relatively cheap and easily available, and through which the laser light is beamed into the X-ray source.

As an example, the laser plasma X-ray source in accordance with the invention can be implemented relatively easily by arranging a target inside the housing and providing the suitable means for emitting the X-ray beams onto the target.

In order to be able to also penetrate smaller vessels, the diameter of the housing transversely to the direction from which the X-ray source is introduced into the body vessel is preferably a maximum of about 1.5 mm, and an optimal diameter is only about 1 mm.

In order to guarantee the best conditions for the development of plasma on the target, the free particle path inside the housing must not be too short. Therefore, the inside of the housing is preferably filled by a vacuum or rarefied gas. A simple forevacuum in the order of 10-1 to 10-3 mbar is sufficient.

Since the X-ray source necessarily comes in contact with the body tissue and/or body fluids of the living being, the housing should be made, at least partially, of a biocompatible material and/or have, at least partially, an outer layer made of biocompatible material. That should be the case at least in those areas that come in direct contact with the body tissue and/or body fluids.

Convenient materials for the housing are glassy carbon (e.g., SIGRADUR) or titanium nitride (TiN). These materials are vacuum-tight and resilient to pressure, and their advantage is that they are characterized by a relatively high blood- and tissue-compatibility. In addition, glassy carbon has a very small density r=1.5 g/cm³ and a low atomic number. Thus, the glassy carbon has a high radiation transparency for X-ray beams.

A suitable biocompatible material for coating the housing of the X-ray source is, for example, nitrile-silicone rubber.

A light conductor connected to the X-ray source serves to irradiate the target with the laser beam. This conductor allows the laser light to conduct from an external laser source through the catheter to the laser plasma X-ray source.

The light conductor can be firmly connected to the housing of the X-ray source. In another design variant, the housing comprises the means for connecting an optical fiber, i.e., the optical fiber and the housing can be separated from each other and thus can, as need be, be separately discarded, recycled, or sterilized again for immediate use.

In a preferred design, the X-ray source includes optics to focus the laser beam on a focal point either directly on the target or at a defined distance from the target. At a given laser intensity, the position of the focal point in relation to the target influences, among other things, both the intensity of the X-ray radiation and the proportion of various types of radiation (bremsstrahlung radiation or K-a-radiation) and thus the X-ray spectrum.

A catheter according to the invention can include only an X-ray source as previously described with an optical fiber connected to it. When such a simple catheter is used, the insertion of the optical fiber simply shifts the X-ray source to the spot to be treated in the patient's body.

The catheter also can include a kind of a catheter shell, hereinafter referred to as an “applicator”, with an X-ray source retainer and a conduit for the optical fiber running longitudinally through the applicator. This type of applicator can be, for example, a suitable small hose or similar device, which includes, for example, further guides to ensure safe delivery of the catheter through all the branching points of the vessel system to the place to be treated. In addition to the X-ray source with its pertaining optical fiber, the catheter also can include other functional elements such as an optical monitoring system with another optical fiber. Using this optical monitoring system, the treating physician or team of physicians can directly observe the place where the X-ray source is located within the body vessel, so that, for example, they can optimize the location of the X-ray source at the place of treatment.

The applicator can be designed in such a manner that it retains an X-ray source with a firmly or detachably connected optical fiber. It is also possible that the optical fiber for the X-ray source can be firmly integrated in the applicator and that, when the X-ray source as outlined by this invention is placed in the X-ray source retainer of the applicator, the optical fiber is automatically coupled with the housing of the X-ray source.

Preferably, the applicator and/or the X-ray source should have matching mounting elements at the X-ray source retainer to attach the X-ray source to the applicator. The X-ray source retainer on the applicator and the X-ray source itself should preferably be designed in such a manner that, when the X-ray source is installed in the X-ray source retainer, it bears closely against the applicator so that, e.g., no fluid can penetrate into the optical fiber conduit of the applicator.

The detachability of the X-ray source from the applicator and/or the optical fiber has the advantage that, during the treatment, either X-ray sources of different target material can be used or worn targets can be replaced.

The X-ray source is usually—but not necessarily—installed at the front end of the catheter.

A system for intracorporeal X-ray radiation according to the invention includes —besides the previously described catheter—a laser arranged outside the living being as well as means (such as suitable launching optics) for launching the laser beam into a light conductor (optical fiber) in order to conduct the laser beam from the external laser through the catheter into the X-ray source of the catheter.

The preferred laser source is a short-pulse laser with a pulse length in the ps range—preferably in the sub-ps range, i.e., in the fs range. The X-ray spectrum influences the penetration depth of the X-ray radiation and thus the extent of the treated volume. As the laser pulse length decreases, the mean X-ray photon energy increases at the same energy per laser pulse and thus the extent of the treated volume. At the same pulse length, the laser photon energy increases with increasing laser intensity. Therefore, in the ideal case, the laser source has devices that allow one to set the laser pulse length and the laser intensity per pulse. Also, preferably, one should be able to set the laser pulse length and the laser intensity independently from each other.

### DESCRIPTION OF THE DRAWINGS

FIG. 1 is a schematic cross-section of an X-ray source in accordance with the invention with an optical fiber firmly attached to the housing of the X-ray source as used within a body vessel.

FIG. 2 is a schematic representation of the system for intracorporeal X-ray irradiation in accordance with the invention.

FIG. 3 is a schematic cross-section of an X-ray source according to the invention with an optical fiber firmly connected to the housing that is led through the applicator of the catheter.

FIG. 4 is a schematic cross-section of an X-ray source according to the invention with an optical fiber connected to the housing in a detachable manner.

### DESCRIPTION OF THE PREFERRED EMBODIMENTS

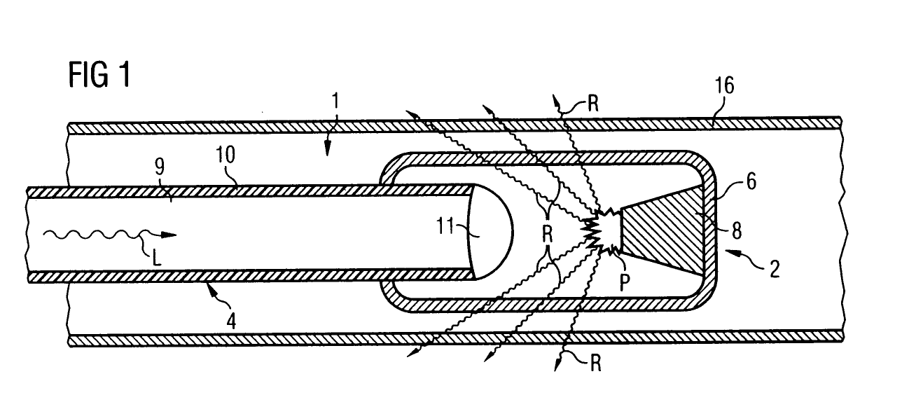

The catheter in accordance with the invention and shown in FIG. 1 is a relatively simple design example. The X-ray source includes a cylindrical housing 6. The housing must be, at least in some areas, penetrable by X-ray radiation, i.e., it must include suitable windows made of X-ray-penetrable material. In the present case, the housing 6 essentially is essentially of an X-ray-transparent, biocompatible material such as glassy carbon.

Target 8 is located on one front side inside the housing 6. Suitable materials for the target are, for example and preferably, Cu, Ar, or Mo. FIG. 1 shows the target only schematically in the form of a conical body. However, the target also can have any other possible form, but especially a foil or similar design positioned by means of suitable mounting elements.

On the front side opposite to that of the target 8, an optical fiber 4 passes through the wall of the housing 6. The optical fiber 4 has a light conductor core 9 and an outer light conductor shell 10 and has a diameter of about 0.3 mm. In the manufacture of the X-ray source 2, the optical fiber 4 was firmly connected to the housing 6 so that the housing 6 is fully sealed by the optical fiber 4.

The inside of the housing 6 is filled with a forevacuum of an order of magnitude between 10⁻¹ and ¹⁰⁻³ mbar in order to increase the free particle path for the development of the plasma.

The optical fiber 4 includes at its end that protrudes into the housing 6 a focusing optics system 11, here in the form of a collimator pen 11 with a short focal distance connected directly to the front face of the optical fiber; this system focuses the laser beam L sent through the light conductor core 9 on a relatively small focal point of several 10 m. This focal point lies, for example, above the target 8 at a very short distance from its surface.

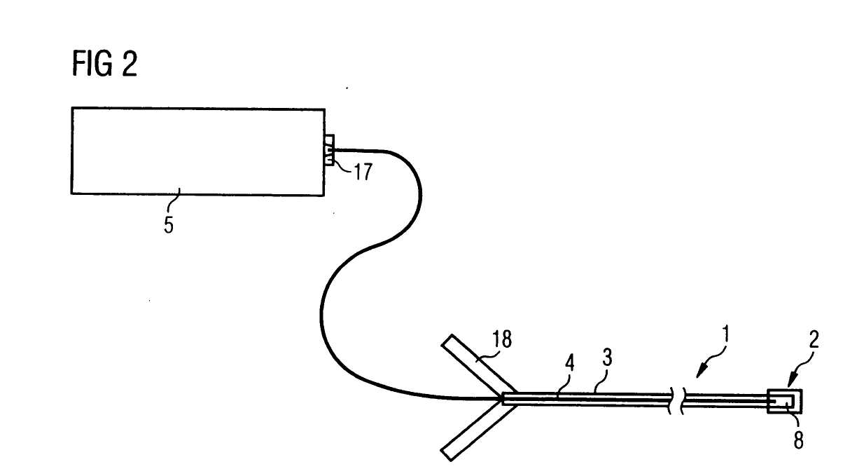

The other end of the optical fiber located outside the patient's body is connected by a coupler to a laser 5 that generates the required laser beam L (See FIG. 2). In this case, it is a short-pulse laser 5, which generates very intensive laser pulses in the fs range. The occurrence of a pulse on the target 8 generates plasma P. In the plasma P hot electrons with energies of several keV develop, and these hot electrons penetrate the upper layers of the relatively cold target 8 and generate X-ray radiation there.

This X-ray radiation R penetrates the walls of the housing 6 and impacts the tissue of the vein or artery 16 to be treated. If the X-ray source 2 is properly placed by the optical fiber 4, an exactly defined zone within the vein or artery 16 is irradiated, i.e., exactly the area where any restenosis is to be prevented. The X-ray radiation occurs only as long as the laser light L is beamed in. As soon as the laser 5 is switched off, the X-ray radiation almost immediately stops being generated.

In an especially optimal embodiment of the invention, the laser 5 generates first a somewhat longer preliminary pulse, which forms on the target 8 a kind of a vapor consisting of the target material. Subsequently, an ultra-short main pulse follows, which generates in the vapor the desired plasma P and thus X-ray radiation.

In a design example as shown in FIG. 1, the X-ray source 2 is simply pushed to the desired position within the vein or artery 16 by means of the optical fiber 4. As shown in FIG. 2, it is also possible to use a catheter with a special applicator 3. This applicator 3 comprises suitable guiding elements 18 in order to better conduct the catheter 1 to the place in the vessel system of the patient to be treated. Optical fiber 4 is passed through the applicator 3. The X-ray source 2 is mounted on the front face of the applicator 3.

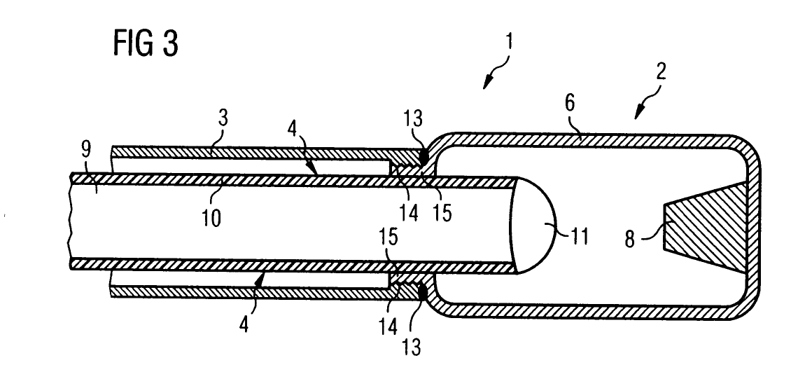

FIG. 3 shows the frontal face of this catheter 1 in an enlarged view. At its end, the applicator 3 comprises an X-ray source retainer, which firmly holds the housing 6 of the X-ray source 2. In the design example that is shown here, at the end of the applicator 3 there is a full-perimeter sealing and the inner side of the end zone of the applicator 3 comprises a thread 14, into which a flange section 15 of the housing 6 of the X-ray source can be screwed. The housing 6 can be connected to the applicator 3 so closely that no body fluid can penetrate into the inner space of the applicator 3, i.e., into the conduit for the optical fiber 4.

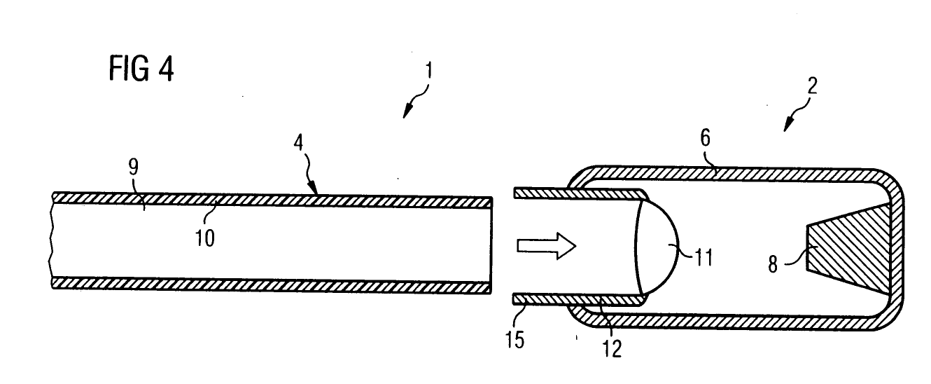

FIG. 4 shows another design example of an X-ray source 2 according to the invention. In this case, the optical fiber 4 is connected to the housing 6 of the X-ray source 2 in a detachable manner. For this purpose, the housing 7 comprises a nozzle 12 that protrudes into the housing 7, whose inner dimensions match the outer dimensions of the optical fiber 4. At its end, the nozzle 12 is closed by a suitable optic device such as a collimator pen 11. The optical fiber 4 is inserted into the nozzle 12 and is retained relatively firmly in that position due to the exact dimensions of the relevant parts. The nozzle 12 extends outside into a kind of flange section 15 with an external thread, which, as in the example design shown in FIG. 3 can be screwed into an inner thread 14 of an applicator 3. This design example has the advantage that all components—applicator 3, X-ray source housing 7, and optical fiber 4—can be separately replaced, appropriately discarded, recycled, or sterilized for another application.

If suitable mounting elements ensure the safe retainment of the optical fiber 4 at the housing 7 of the X-ray source 2, such a catheter with an X-ray source 2, which comprises an optical fiber 4 that is detachable from the X-ray source housing 7, can be also used without an applicator 3.

In order to use this apparatus for the treatment of humans, the maximum diameter of the housing 6, 7 of the X-ray source 2 transversely to the intended direction of the introduction of the X-ray source 2 into the body vessel 16, i.e., in the housing shown in FIGS. 1 to 4 the cylinder diameter of housings 6, 7—should be a maximum of about 2 mm. The diameter should preferably be only about 1.5 mm, and an optimal diameter would be about 1 mm.

Previously, the use of an X-ray tube 2 in accordance with the present invention for the treatment of stenosis of arteries and veins was described. However, the X-ray tubes, the catheter, or the system as designed by this invention can generally be used for intracorporeal X-ray therapy. For example, they can be used for the therapy of joints, for the treatment of tumors or for similar diseases. In addition, the use is not limited to the medical field. The application of the X-ray tube and/or the catheter as designed by the invention makes sense in any places with difficult access where an X-ray source is required.

Although modifications and changes may be suggested by those skilled in the art, it is the intention of the inventors to embody within the patent warranted hereon all changes and modifications as reasonably and properly come within the scope of their contribution to the art.

We claim as our invention:

1. An X-ray source comprising:
a laser plasma X-ray source; and
a housing containing said laser plasma X-ray source, said housing being adapted for introduction into a vessel of a living subject along an introduction direction, said housing having a diameter transversely to said introduction direction of no more than about 2 mm.

2. An X-ray source as claimed in claim 1 wherein said housing has a diameter transversely to said introduction direction of no more than about 1.5 mm.

3. An X-ray source as claimed in claim 1 wherein said housing has a diameter transversely to said introduction direction of no more than about 1 mm.

4. An X-ray source as claimed in claim 1 for use with a laser beam source disposed outside of said housing and comprising a light conductor adapted to couple a laser beam from said laser beam source into an interior of said housing, and a target disposed in said housing on which said laser beam is incident.

5. An X-ray source as claimed in claim 4 comprising an optical focusing arrangement disposed in said housing for focusing said laser beam onto a focal spot on said target.

6. An X-ray source as claimed in claim 4 comprising an optical focusing arrangement disposed in said housing for focusing said laser beam to a focal point at a predetermined distance from said target.

7. An X-ray source as claimed in claim 4 wherein said light conductor is an optical fiber.

8. An X-ray source as claimed in claim 7 wherein said optical fiber has a front face, and comprising an optical focusing device for said X-ray beam disposed at said front face of said optical fiber.

9. An X-ray source as claimed in claim 4 wherein said housing has a cylindrical shape having opposite end faces, and wherein said target is disposed at a first of said end faces inside said housing and wherein a second of said end faces comprises a coupling arrangement for said light conductor.

10. An X-ray source as claimed in claim 4 wherein said housing has a cylindrical shape with opposite end faces, and wherein said target is disposed at a first of said end faces inside of said housing, and wherein said housing comprises an optical fiber, coupled to said light conductor, at a second of said end faces.

11. An X-ray source as claimed in claim 1 wherein said housing contains a rarefied gas.

12. An X-ray source as claimed in claim 1 wherein said housing contains a vacuum.

13. An X-ray source as claimed in claim 1 wherein said housing is comprised at least partially of a biocompatible material.

14. An X-ray source as claimed in claim 1 comprising an exterior layer at least partially covering said housing, said exterior layer being comprised of a biocompatible material.

15. A catheter arrangement comprising:
a catheter adapted for insertion into a vessel of a body of a living subject; and
a laser plasma X-ray source carried by said catheter and adapted for introduction into the vessel together with the catheter along an introduction direction, said laser plasma X-ray source having a housing having a diameter transversely to said introduction direction of no more than about 2 mm.

16. A catheter arrangement as claimed in claim 15 for use with an extracorporeally disposed laser beam source, said catheter arrangement comprising an applicator having a free end at which said X-ray source is disposed, and a longitudinal conduit adapted to receive an optical fiber therein coupling said X-ray source to said laser beam source.

17. A catheter arrangement as claimed in claim 15 for use with an extracorporeally disposed laser beam source, said catheter arrangement comprising an applicator having a free end at which a retainer for said X-ray source is disposed, said applicator having an optical fiber integrated therein optically coupled to said X-ray source and adapted for optical coupling to said extracorporeally disposed laser beam source.

18. A catheter arrangement as claimed in claim 15 comprising an applicator having a free end at which a retainer for said X-ray source is disposed, said retainer comprising mounting elements for attaching said X-ray source to said applicator.

19. A catheter arrangement as claimed in claim 18 wherein said mounting elements hold said X-ray source adjacent to said free end of said applicator.

20. A system for extracorporeal X-ray irradiation comprising:
an extracorporeally disposed laser beam source;
a catheter adapted for insertion into a vessel of a body of a living subject;
a laser plasma X-ray source carried by said catheter and adapted for introduction with said catheter into said vessel along an introduction direction, said laser plasma X-ray source having a housing with a diameter, transversely to said introduction direction, of no more than about 2 mm; and
a light conductor proceeding longitudinally through said catheter and optically coupling said extracorporeally disposed laser beam source with said x-ray source.

21. A system as claimed in claim 20 wherein said extracorporeally disposed laser beam source is a short-pulse laser.

22. A system as claimed in claim 20 wherein said extracorporeally disposed laser beam source emits a laser pulse having a duration, and comprising a control unit for setting said duration.

23. A system as claimed in claim 20 wherein said extracorporeally disposed laser beam source emits a laser pulse having an intensity, and comprising a control unit for setting said intensity.
